(19) United States
(12) Patent Application Publication
(10) Pub. No.: US 2026/0113069 A1
(43) Pub. Date: Apr. 23, 2026

(54) COMMUNICATION DEVICE AND COMMUNICATION SYSTEM HAVING THE SAME

(71) Applicant: LITE-ON TECHNOLOGY CORPORATION, Taipei (TW)

(72) Inventor: Lin-Hui MA, Taipei (TW)

(21) Appl. No.: 19/325,562

(22) Filed: Sep. 11, 2025

Related U.S. Application Data
(60) Provisional application No. 63/710,614, filed on Oct. 23, 2024.
(60) Provisional application No. 63/745,354, filed on Jan. 15, 2025.

(30) Foreign Application Priority Data
Jun. 18, 2025 (CN) 202510817297.9

(51) Int. Cl. H04B 1/40

(52) U.S. Cl. CPC H04B 1/40

(57) ABSTRACT

A communication device comprises a substrate, a first transceiver module, a second transceiver module, and a first circulator, a second circulator, a first antenna module, a second antenna module and a shielding frame disposed on a surface of the substrate. The first and second transceiver modules are disposed on two opposite sides of the surface of the substrate. The first and second circulators are respectively electrically or communicatively connected to the first and second transceiver modules through the substrate. The first and second antenna modules are respectively electrically or communicatively connected to the first and second circulators through the substrate. The shielding frame defines closed separated areas therein, so that the first and second transceiver modules are distributed in these separated areas, or the first and second transceiver modules and the first and second circulators are distributed in these separated areas.

This application claims the benefit of the U.S. provisional application Ser. No. 63/710,614, filed Oct. 23, 2024, the U.S. provisional application Ser. No. 63/745,354, filed Jan. 15, 2025, and CN application Serial No. 202510817297.9, filed Jun. 18, 2025, the disclosures of which are incorporated by reference herein in its entirety.

### TECHNICAL FIELD

The present invention relates to a communication device and a communication system having the same, and more particularly, to a communication device and a communication system having the same that can enhance the isolation of a multiple input multiple output (MIMO) antenna system.

### BACKGROUND

With the increasing popularity of wireless communication devices, practitioners in the related field are faced with challenges from various radio waves originating from multiple sources. These electromagnetic waves may radiate within the same spectrum and cause electromagnetic interference (EMI). In view of this, radio frequency transceiver communication components must be effectively isolated to limit the interference of electromagnetic waves to nearby components and prevent degradation of the performance of these communication components. Accordingly, how to effectively enhance the isolation of antenna systems has become a direction pursued by practitioners in the art.

### SUMMARY

In view of the prior art, the present invention provides a novel communication device that enhances the isolation of a multiple input multiple output antenna system and achieves a low error vector magnitude (EVM) by designing a shielding frame that defines a plurality of closed separated areas therein and distributing a first transceiver module, a second transceiver module, a first circulator, and a second circulator in these separated areas, thereby improving the quality of communication signals.

Specifically, according to a first aspect of the present invention, a communication device is provided. The communication device comprises a substrate, a first transceiver module, a second transceiver module, a first circulator, a second circulator, a first antenna module, a second antenna module and a shielding frame. The first transceiver module is disposed on one side of a surface of the substrate. The second transceiver module is disposed on the surface of the substrate and located on another side opposite to the first transceiver module. The first circulator, the second circulator, the first antenna module, the second antenna module and the shielding frame are disposed on the surface of the substrate. The first circulator is electrically or communicatively connected to the first transceiver module through the substrate to separate a transmitting path and a receiving path of the first transceiver module. The second circulator is electrically or communicatively connected to the second transceiver module through the substrate to separate a transmitting path and a receiving path of the second transceiver module. The first antenna module is electrically or communicatively connected to the first circulator through the substrate to receive or transmit signals. The second antenna module is electrically or communicatively connected to the second circulator through the substrate to receive or transmit signals. The shielding frame defines a plurality of closed separated areas therein, so that the first and second transceiver modules are distributed in these separated areas, or the first transceiver module, the second transceiver module, the first circulator, and the second circulator are distributed in these separated areas.

Further, according to a second aspect of the present invention, a communication system is provided. The communication system comprises two communication devices according to the first aspect of the present invention, a processing unit and a frequency synthesizer. The substrates of the two communication devices are the same substrate. The substrate has a first side edge and a second side edge opposite to each other, wherein one of the two communication devices is adjacent to the first side edge, and the other one of the two communication devices is adjacent to the second side edge. The processing unit and the frequency synthesizer are disposed on the substrate. The processing unit is located below one of the two communication devices. The frequency synthesizer is located below the other one of the two communication devices. A distance between the frequency synthesizer and the first side edge of the substrate is equal to a distance between the frequency synthesizer and the processing unit.

The above summary is not intended to represent all embodiments or all aspects of the present invention. On the contrary, the above summary is merely provided as some examples illustrating novel aspects and features of the present invention. In order to make the embodiments and other objects, features, and advantages of the present invention more apparent and understandable, preferred embodiments are described in detail below with reference to the accompanying drawings. After the detailed description of various embodiments with reference to the drawings, those skilled in the art will be more able to understand other aspects of the present invention. A brief description of the drawings is provided as follows.

### BRIEF DESCRIPTION OF THE DRAWINGS

FIG. 1 illustrates a schematic top view of a configuration of a communication device according to a first embodiment of the present invention.

FIG. 2 illustrates a schematic top view of a configuration of a communication device according to a second embodiment of the present invention.

FIG. 3 illustrates a schematic top view of a configuration of a communication system according to a third embodiment of the present invention.

FIG. 4 illustrates a schematic top view of a configuration of a communication system according to a fourth embodiment of the present invention.

### DETAILED DESCRIPTION

Detailed descriptions of the embodiments of the specification are disclosed below with reference to the accompanying drawings. Apart from the detailed descriptions provided, any embodiments in which the present invention can be used as well as any substitutions, modifications or equivalent changes of the said embodiments are within the scope of the disclosure, and the descriptions and definitions in the claims shall prevail. In the following detailed description, for purposes of explanation, numerous specific details are set forth in order to provide a thorough understanding of the disclosed embodiments. It will be apparent, however, that one or more embodiments may be practiced without these specific details. Additionally, well-known common steps or components are not described in detail to avoid unnecessarily limiting the present invention. The same or similar elements in the figures are represented by the same or similar symbols. It is important to note that the drawings are for illustration purposes only and do not represent the actual size or quantity of components, unless otherwise specified.

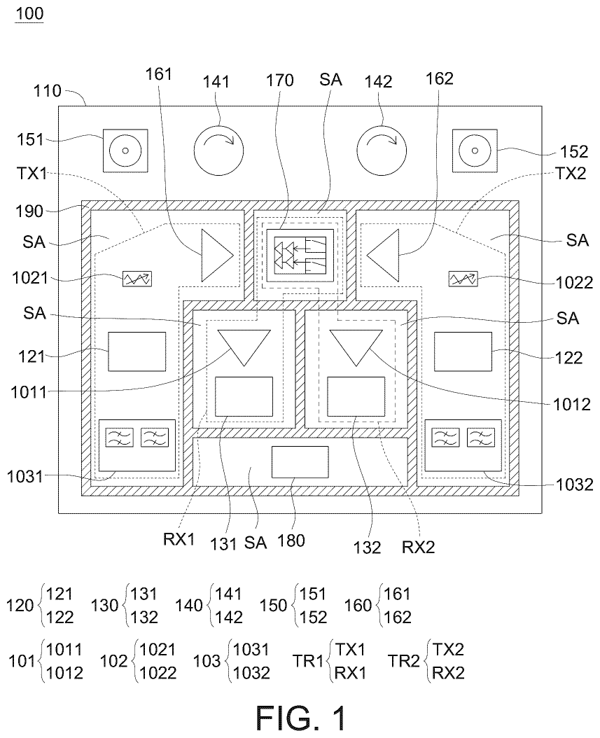

Please refer to FIG. 1, which is a top view illustrating the configuration of a communication device 100 according to a first embodiment of the present invention.

The communication device 100 of the present invention may, for example, be applied to a small cell of a fourth generation (4G) mobile communication technology or a fifth generation (5G) mobile communication technology. As shown in FIG. 1, the communication device 100 may comprise a substrate 110, a modulator 120, a demodulator 130, a circulator 140, an antenna module 150, a power amplifier (PA) 160, a receiving switch module 170, a clock buffer 180, and a shielding frame 190. The modulator 120, the demodulator 130, the circulator 140, the antenna module 150, the power amplifier 160, the receiving switch module 170, the clock buffer 180, and the shielding frame 190 may be disposed on a surface of the substrate 110. For example, the substrate 110 may be a printed circuit board (PCB).

The modulator 120 is used for a transmitting side to convert digital data into a radio frequency (RF) signal that can be transmitted. The demodulator 130 is used on a receiving side to restore the original digital data of the signal. The circulator 140 is used to separate a transmitting path (TX path) and a receiving path (RX path) to ensure that signal transmission and reception do not interfere with each other. The antenna module 150 includes an antenna base (as shown in FIG. 1) and an antenna (not shown in the figure) connected to the antenna base, and is used to receive or transmit signals, thereby entering the receiving path or the transmitting path. The power amplifier 160 is used to amplify the signal to a level that can be transmitted by the antenna. The receiving switch module 170 may be a receiver front end (RXFE) and is used to switch whether to receive signals. The clock buffer 180 is electrically or communicatively connected to the modulator 120 and the demodulator 130 through the substrate 110, and is used to provide an operation frequency and ensure the synchronous operation of the overall transceiver paths and the signal timing consistency.

In this embodiment, the number of the modulator 120, the demodulator 130, the circulator 140, the antenna module 150, and the power amplifier 160 may be configured in multiples (e.g., two for these components). Specifically, two modulators 120 may be provided, such as a first modulator 121 and a second modulator 122. Two demodulators 130 may be provided, such as a first demodulator 131 and a second demodulator 132. Two circulators 140 may be provided, such as a first circulator 141 and a second circulator 142. Two antenna modules 150 may be provided, such as a first antenna module 151 and a second antenna module 152. Two power amplifiers 160 may be provided, such as a first power amplifier 161 and a second power amplifier 162. The first antenna module 151 and the second antenna module 152 respectively correspond to the first circulator 141 and the second circulator 142, so that the first antenna module 151 and the second antenna module 152 each has an independent transceiver channel, thereby enabling the communication device 100 to serve as a 2T2R MIMO antenna system. The first antenna module 151 is electrically or communicatively connected to the first circulator 141 through the substrate 110 to receive or transmit signals. The second antenna module 152 is electrically or communicatively connected to the second circulator 142 through the substrate 110 to receive or transmit signals. As shown in FIG. 1, the communication device 100 has two sets of left-right symmetrical transmitting and receiving paths. The first circulator 141 and the second circulator 142 at the center provide the transmitting and receiving paths of signals and are respectively matched with the first antenna module 151 and the second antenna module 152.

The communication device 100 may further comprise a low-noise amplifier (LNA) 101. The low-noise amplifier 101 is disposed on the substrate 110 and may be used to perform a primary amplification on weak signals. The number of low-noise amplifiers 101 may be configured as two, such as a first low-noise amplifier 1011 and a second low-noise amplifier 1012. The first low-noise amplifier 1011, the first demodulator 131, and the receiving switch module 170 may constitute a first receiving unit RX1. The second low-noise amplifier 1012, the second demodulator 132 and the receiving switch module 170 may constitute a second receiving unit RX2. That is, the first receiving unit RX1 and the second receiving unit RX2 may share the same receiving switch module 170. The communication device 100 may further comprise a digital step attenuator (DSA) 102. The digital step attenuator 102 is disposed on the substrate 110 and may be used to control the output power of radio frequency signals by means of step attenuation. The number of digital step attenuators 102 may be configured as two, such as a first digital step attenuator 1021 and a second digital step attenuator 1022. Further, the communication device 100 may further comprise an intermediate frequency amplifier (IF AMP) 103. The intermediate frequency amplifier 103 is disposed on the substrate 110 and may be used to perform a power compensation and a linear amplification on intermediate frequency signals after a frequency conversion. The number of the intermediate frequency amplifiers 103 may be configured as two, such as a first intermediate frequency amplifier 1031 and a second intermediate frequency amplifier 1032. The first digital step attenuator 1021, the first intermediate frequency amplifier 1031, the first modulator 121, and the first power amplifier 161 may constitute a first transmitting unit TX1 to provide a transmitting path of signals of the first antenna module 151. The second digital step attenuator 1022, the second intermediate frequency amplifier 1032, the second modulator 122 and the second power amplifier 162 may constitute a second transmitting unit TX2 to provide a transmitting path of signals of the second antenna module 152.

The first transmitting unit TX1 and the first receiving unit RX1 may constitute a first transceiver module TR1, i.e., the first transceiver module TR1 comprises the first transmitting unit TX1 and the first receiving unit RX1. The second transmitting unit TX2 and the second receiving unit RX2 may constitute a second transceiver module TR2, i.e., the second transceiver module TR2 comprises the second transmitting unit TX2 and the second receiving unit RX2. The first transceiver module TR1 is disposed on one side of a surface of the substrate 110, and the second transceiver module TR2 is disposed on the surface of the substrate 110 and located on another side opposite to the first transceiver module TR1. The first circulator 141 may be electrically or communicatively connected to the first transceiver module TR1 through the substrate 110 to separate a transmitting path and a receiving path of the first transceiver module TR1. The second circulator 142 may be electrically or communicatively connected to the second transceiver module TR2 through the substrate 110 to separate a transmitting path and a receiving path of the second transceiver module TR2. The clock buffer 180 may be located between the first transceiver module TR1 and the second transceiver module TR2, and may be electrically or communicatively connected to the first transceiver module TR1 and the second transceiver module TR2 through the substrate 110 to provide an operation frequency to the first transceiver module TR1 and the second transceiver module TR2. The first transmitting unit TX1 and the first receiving unit RX1 of the first transceiver module TR1 are respectively electrically or communicatively connected to the first circulator 141. The second transmitting unit TX2 and the second receiving unit RX2 of the second transceiver module TR2 are respectively electrically or communicatively connected to the second circulator 142.

The shielding frame 190 may define a plurality of closed separated areas SA therein, so that the first transceiver module TR1 and the second transceiver module TR2 are distributed in these separated areas SA. Specifically, the modulator 120, the demodulator 130, the power amplifier 160, the receiving switch module 170, the clock buffer 180, the low-noise amplifier 101, the digital step attenuator 102 and the intermediate frequency amplifier 103 may be distributed in these separated areas SA. The first transmitting unit TX1 and the first receiving unit RX1 of the first transceiver module TR1 are distributed in these separated areas SA to isolate the first transmitting unit TX1 and the first receiving unit RX1. The second transmitting unit TX2 and the second receiving unit RX2 of the second transceiver module TR2 are distributed in these separated areas SA to isolate the second transmitting unit TX2 and the second receiving unit RX2. As shown in FIG. 1, the first power amplifier 161 and the first modulator 121 are located in the same separated area SA, and the second power amplifier 162 and the second modulator 122 are located in another same separated area SA. Further, the first digital step attenuator 1021 and the first intermediate frequency amplifier 1031 may be located in the same separated area SA as the first power amplifier 161 and the first modulator 121, while the second digital step attenuator 1022 and the second intermediate frequency amplifier 1032 may be located in the same separated area SA as the second power amplifier 162 and the second modulator 122. The receiving switch module 170 is independently located in a single separated area SA. The clock buffer 180 is also independently located in a single separated area SA. The first demodulator 131 and the first low-noise amplifier 1011 are located in the same separated area SA, and the second demodulator 132 and the second low-noise amplifier 1012 are located in another same separated area SA. In summary, the first modulator 121 and the second modulator 122, the first demodulator 131 and the second demodulator 132, the first power amplifier 161 and the second power amplifier 162, the receiving switch module 170, and the clock buffer 180 are distributed in different six of these separated areas SA, while the circulator 140 and the antenna module 150 are disposed outside the shielding frame 190, i.e., not located in any separated area SA defined inside the shielding frame 190.

In this embodiment, as shown in FIG. 1, the shielding frame 190 is an integrally formed component, and specifically may be made of metal. The shielding frame 190 may be used to suppress external electromagnetic interference from entering and to prevent internal signals from leaking, thereby improving electromagnetic compatibility and signal integrity of the system. Further, the shielding frame 190 included in the communication device 100 of the present invention is an integrally formed single component, which has technical advantages of lower mold development cost and simple assembly.

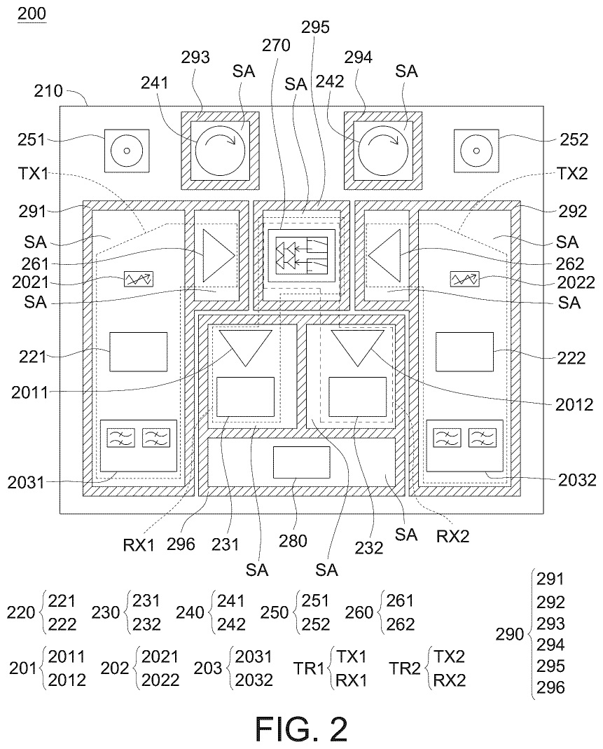

Please refer to FIG. 2, which is a schematic top view of the configuration of a communication device 200 according to a second embodiment of the present invention.

The communication device 200 of the present invention may, for example, be applied to a small base station of 4G communication technology or 5G communication technology. As shown in FIG. 2, the communication device 200 may comprise a substrate 210, a modulator 220, a demodulator 230, a circulator 240, an antenna module 250, a power amplifier 260, a receiving switch module 270, a clock buffer 280, and a shielding frame 290. The modulator 220, the demodulator 230, the circulator 240, the antenna module 250, the power amplifier 260, the receiving switch module 270, the clock buffer 280, and the shielding frame 290 may all be disposed on a surface of the substrate 210. For example, the substrate 210 may be a printed circuit board.

The modulator 220 is used for a transmitting side to convert digital data into a radio frequency signal that can be transmitted. The demodulator 230 is used for a receiving side to restore the original digital data of the signal. The circulator 240 is used to separate a transmitting path and a receiving path to ensure that signal transmission and reception do not interfere with each other. The antenna module 250 includes an antenna base (as shown in FIG. 2) and an antenna (not shown in the figure) connected to the antenna base, and is used to receive or transmit signals, thereby entering the receiving path or the transmitting path. The power amplifier 260 is used to amplify the signal to a level that can be transmitted by the antenna. The receiving switch module 270 may be a receiver front end and is used to switch whether to receive signals. The clock buffer 280 is electrically or communicatively connected to the modulator 220 and the demodulator 230 through the substrate 210, and is used to provide an operation frequency and ensure the synchronous operation of the overall transceiver paths and the signal timing consistency.

In this embodiment, the number of the modulator 220, the demodulator 230, the circulator 240, the antenna module 250, and the power amplifier 260 may be configured in multiples (e.g., two for these components). Specifically, two modulators 220 may be provided, such as a first modulator 221 and a second modulator 222. Two demodulators 230 may be provided, such as a first demodulator 231 and a second demodulator 232. Two circulators 240 may be provided, such as a first circulator 241 and a second circulator 242. Two antenna modules 250 may be provided, such as a first antenna module 251 and a second antenna module 252. Two power amplifiers 260 may be provided, such as a first power amplifier 261 and a second power amplifier 262. The first antenna module 251 and the second antenna module 252 respectively correspond to the first circulator 241 and the second circulator 242, so that the first antenna module 251 and the second antenna module 252 each has an independent transceiver channel, thereby enabling the communication device 200 to serve as a 2T2R MIMO antenna system. The first antenna module 251 may be electrically or communicatively connected to the first circulator 241 through the substrate 210 to receive or transmit signals. The second antenna module 252 may be electrically or communicatively connected to the second circulator 242 through the substrate 210 to receive or transmit signals. As shown in FIG. 2, the communication device 200 has two sets of left-right symmetrical transmitting and receiving paths. The first circulator 241 and the second circulator 242 at the center provide the transmitting and receiving paths of signals and are respectively matched with the first antenna module 251 and the second antenna module 252.

The communication device 200 may further comprise a low-noise amplifier 201. The low-noise amplifier 201 is disposed on the substrate 210 and may be used to perform a primary amplification on weak signals. The number of the low-noise amplifier 201 may be configured as two, such as a first low-noise amplifier 2011 and a second low-noise amplifier 2012. The first low-noise amplifier 2011, the first demodulator 231, and the receiving switch module 270 may constitute a first receiving unit RX1. The second low-noise amplifier 2012, the second demodulator 232, and the receiving switch module 270 may constitute a second receiving unit RX2. That is, the first receiving unit RX1 and the second receiving unit RX2 may share the same receiving switch module 270. The communication device 200 may further comprise a digital step attenuator 202. The digital step attenuator 202 is disposed on the substrate 210 and may be used to control the output power of radio frequency signals by means of step attenuation. The number of the digital step attenuator 202 may be configured as two, such as a first digital step attenuator 2021 and a second digital step attenuator 2022. Further, the communication device 200 may further comprise an intermediate frequency amplifier 203. The intermediate frequency amplifier 203 is disposed on the substrate 210 and is used to perform a power compensation and a linear amplification on intermediate frequency signals after frequency conversion. The number of the intermediate frequency amplifier 203 may be configured as two, such as a first intermediate frequency amplifier 2031 and a second intermediate frequency amplifier 2032. The first digital step attenuator 2021, the first intermediate frequency amplifier 2031, the first modulator 221, and the first power amplifier 261 may constitute a first transmitting unit TX1 to provide a transmitting path of a signal of the first antenna module 251. The second digital step attenuator 2022, the second intermediate frequency amplifier 2032, the second modulator 222, and the second power amplifier 262 may constitute a second transmitting unit TX2 to provide a transmitting path of a signal of the second antenna module 252.

The first transmitting unit TX1 and the first receiving unit RX1 may constitute a first transceiver module TR1, i.e., the first transceiver module TR1 comprises the first transmitting unit TX1 and the first receiving unit RX1. The second transmitting unit TX2 and the second receiving unit RX2 may constitute a second transceiver module TR2, i.e., the second transceiver module TR2 comprises the second transmitting unit TX2 and the second receiving unit RX2. The first transceiver module TR1 is disposed on one side of a surface of the substrate 210, and the second transceiver module TR2 is disposed on the surface of the substrate 210 and located on another side opposite to the first transceiver module TR1. The first circulator 241 may be electrically or communicatively connected to the first transceiver module TR1 through the substrate 210 to separate a transmitting path and a receiving path of the first transceiver module TR1. The second circulator 242 may be electrically or communicatively connected to the second transceiver module TR2 through the substrate 210 to separate a transmitting path and a receiving path of the second transceiver module TR2. The clock buffer 280 may be located between the first transceiver module TR1 and the second transceiver module TR2, and may be electrically or communicatively connected to the first transceiver module TR1 and the second transceiver module TR2 through the substrate 210 to provide an operation frequency to the first transceiver module TR1 and the second transceiver module TR2. The first transmitting unit TX1 and the first receiving unit RX1 of the first transceiver module TR1 are respectively electrically or communicatively connected to the first circulator 241. The second transmitting unit TX2 and the second receiving unit RX2 of the second transceiver module TR2 are respectively electrically or communicatively connected to the second circulator 242.

The shielding frame 290 may define a plurality of closed separated areas SA therein, such that the first transceiver module TR1, the second transceiver module TR2, and the first circulator 241 and the second circulator 242 of the circulator 240 are distributed in these separated areas SA. Specifically, the modulator 220, the demodulator 230, the circulator 240, the power amplifier 260, the receiving switch module 270, the clock buffer 280, the low-noise amplifier 201, the digital step attenuator 202, and the intermediate frequency amplifier 203 may be distributed in the separated areas SA. The difference from the first embodiment lies in that, in this embodiment, the shielding frame 290 includes a plurality of separately disposed shielding members 291 to 296. The shielding members 291 to 296 each define at least one separated area SA. The shielding members 291 and 292 are arranged symmetrically, and each of the shielding members 291 and 292 defines two separated areas SA. The shielding members 293 and 294 are arranged symmetrically, and each of the shielding members 293 and 294 defines a single separated area SA. The shielding members 295 and 296 are disposed between the shielding members 291 and 292. The shielding member 295 defines a single separated area SA, while the shielding member 296 defines three separated areas SA. The shielding members 291 to 296 of the shielding frame 290 may specifically be made of metal.

As shown in FIG. 2, the first power amplifier 261 and the first modulator 221 are located in two different separated areas SA defined by the shielding member 291, while the second power amplifier 262 and the second modulator 222 are located in two different separated areas SA defined by the shielding member 292. That is, the difference from the first embodiment lies in that the power amplifier and the modulator are isolated from each other through the shielding frame. The first circulator 241 and the second circulator 242 are respectively located in the shielding members 293 and 294. That is, the first circulator 241 and the second circulator 242 are located in two different shielding members among the shielding members 291 to 296 disposed separately. Thus, the difference from the first embodiment lies in that the circulators are isolated through the shielding frame. The first demodulator 231, the second demodulator 232, and the clock buffer 280 are located in three different separated areas SA defined by the shielding member 296, wherein the clock buffer 280 is located alone in one of the separated areas SA, the first demodulator 231 and the first low-noise amplifier 2011 are located in another separated area SA, and the second demodulator 232 and the second low-noise amplifier 2012 are located in another separated area SA. Further, the first digital step attenuator 2021 and the first intermediate frequency amplifier 2031 may be located in the same separated area SA as the first modulator 221, while the second digital step attenuator 2022 and the second intermediate frequency amplifier 2032 may be located in the same separated area SA as the second modulator 222. The receiving switch module 270 is located alone in a single separated area SA of the shielding member 295. In summary, the first modulator 221 and the second modulator 222, the first demodulator 231 and the second demodulator 232, the first circulator 241 and the second circulator 242, the first power amplifier 261 and the second power amplifier 262, the receiving switch module 270, and the clock buffer 280 are distributed in ten different separated areas SA defined by the shielding members 291 to 296, while the antenna module 250 is disposed outside the shielding frame 290, i.e., not located in any separated area SA defined inside the shielding frame 290.

The shielding frame 290 may be used to suppress external electromagnetic interference from entering and to prevent internal signals from leaking, thereby improving the electromagnetic compatibility and signal integrity of the system. Further, the shielding frame 290 of the communication device 200 in the second embodiment of the present invention includes a plurality of independently formed shielding members 291 to 296. By disposing the shielding members 291 to 296 separately and isolating the circulator 240 with shielding, the communication device 200 can further reduce the EVM compared with the communication device 100 of the first embodiment, thereby providing better communication signal quality. Furthermore, since the shielding frame 290 is divided into shielding members 291 to 296, the individual area is reduced, thereby avoiding the problem that the shielding frame of the first embodiment with a large monolithic area tends to tilt, and improving the difficulty of grasping the shielding frame during the process of installing components on the substrate.

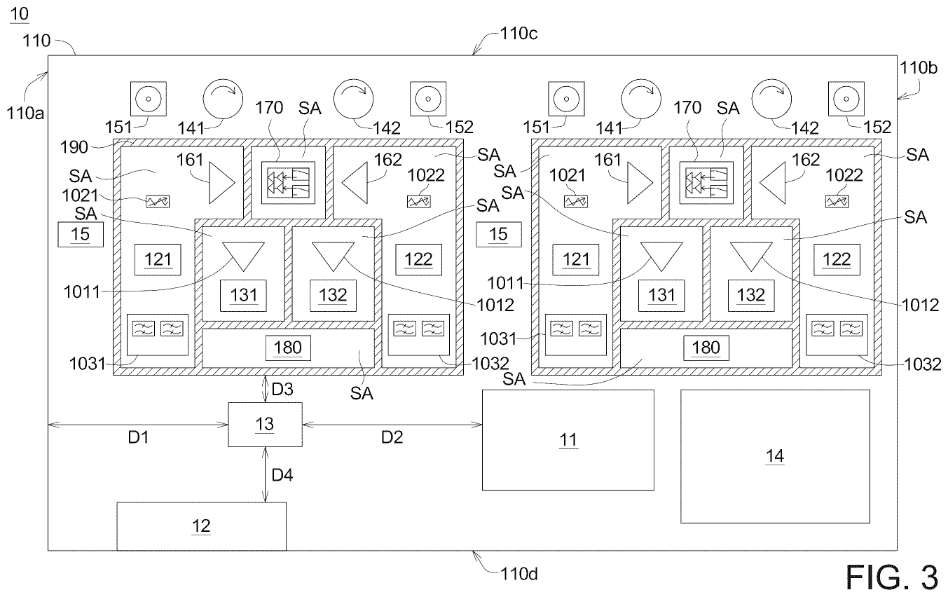

Please refer to FIG. 3, which is a top view illustrating the configuration of a communication system 10 according to a third embodiment of the present invention.

As shown in FIG. 3, the communication system 10 can comprise two communication devices 100 of the aforementioned first embodiment, a processing unit 11, a port 12, a frequency synthesizer 13, a converter 14 and a regulator 15. These components are disposed on a substrate 110 and located outside the two shielding frames 190 of the two communication devices 100, wherein the substrate 110 is a single substrate. That is, the two communication devices 100 can share the same substrate 110, and the components disposed on the substrate 110 can be communicatively or electrically connected with each other as required. The substrate 110 has a first side 110a and a second side 110b opposite to each other in the left-right direction, and a third side 110c and a fourth side 110d opposite to each other in the up-down direction. Specifically, one of the two communication devices 100 is located adjacent to the first side 110a of the substrate 110, and the other one is located adjacent to the second side 110b of the substrate 110. The port 12 and the frequency synthesizer 13 are disposed below one of the two communication devices 100, and the port 12 is adjacent to the fourth side 110d of the substrate 110. The processing unit 11 and the converter 14 are disposed below one of the two communication devices 100, and the regulator 15 is disposed between the two communication devices 100.

In this embodiment, the processing unit 11 can be a central processing unit (CPU) and is electrically or communicatively connected to the two communication devices 100 for controlling the two communication devices 100 to respectively receive or transmit signals. The port 12 is used to connect with an external power supply. The frequency synthesizer 13 is electrically or communicatively connected to the two clock buffers 180 of the two communication devices 100, so as to evenly provide an operation frequency to the two clock buffers 180, thereby reducing problems caused by a small signal or delay from a single clock source within a limited space. The converter 14 can be a power converter and is electrically connected to the port 12, and the converter 14 is used to receive an external power supply (such as a DC power supply) from the port 12 and step down the external power supply to match the operating voltage required by the components of the communication system 10. The regulator 15 can be a low-dropout regulator (LDO), electrically connected to the converter 14 to receive the operating voltage therefrom, so as to regulate the voltage and provide a stable DC power supply.

In an embodiment, a distance D1 between the first side 110a of the substrate 110 and the frequency synthesizer 13 is equal to a distance D2 between the frequency synthesizer 13 and the processing unit 11. In this way, the frequency synthesizer 13 can maintain a predetermined distance from the processing unit 11, such that the operation of the frequency synthesizer 13 is not affected by the heat generated from the processing unit 11, while the frequency synthesizer 13 is not too far from the other one of the two communication devices 100 (i.e., the communication device 100 adjacent to the second side 110b of the substrate 110), thereby ensuring that the frequency synthesizer 13 can effectively transmit the operation frequency to the communication device 100 adjacent to the second side 110b. In another embodiment, a distance D3 between one of the two communication devices 100 (i.e., the communication device 100 adjacent to the first side 110a of the substrate 110) and the frequency synthesizer 13 is smaller than a distance D4 between the frequency synthesizer 13 and the port 12, such that the operation of the frequency synthesizer 13 is not affected by the heat generated from the port 12. In detail, the distance D3 can be defined as a distance between the shielding frame 190 of the communication device 100 adjacent to the first side 110a of the substrate 110 and the frequency synthesizer 13.

Accordingly, in this embodiment, by using the two communication devices 100, the communication system 10 can function as a 4T4R MIMO antenna system. When the communication system 10 as the 4T4R MIMO antenna system operates, the processing unit 11 typically generates relatively high heat, while the port 12 generates relatively low heat. If the frequency synthesizer 13 is too close to the processing unit 11, noise may be introduced into the system. Therefore, in this embodiment, the placement of the frequency synthesizer 13 is carefully designed. By making the distance D1 between the frequency synthesizer 13 and the first side 110a of the substrate 110 equal to the distance D2 between the frequency synthesizer 13 and the processing unit 11, and/or making the distance D3 between the frequency synthesizer 13 and the communication device 100 adjacent to the first side 110a smaller than the distance D4 between the frequency synthesizer 13 and the port 12, interference noise can be prevented.

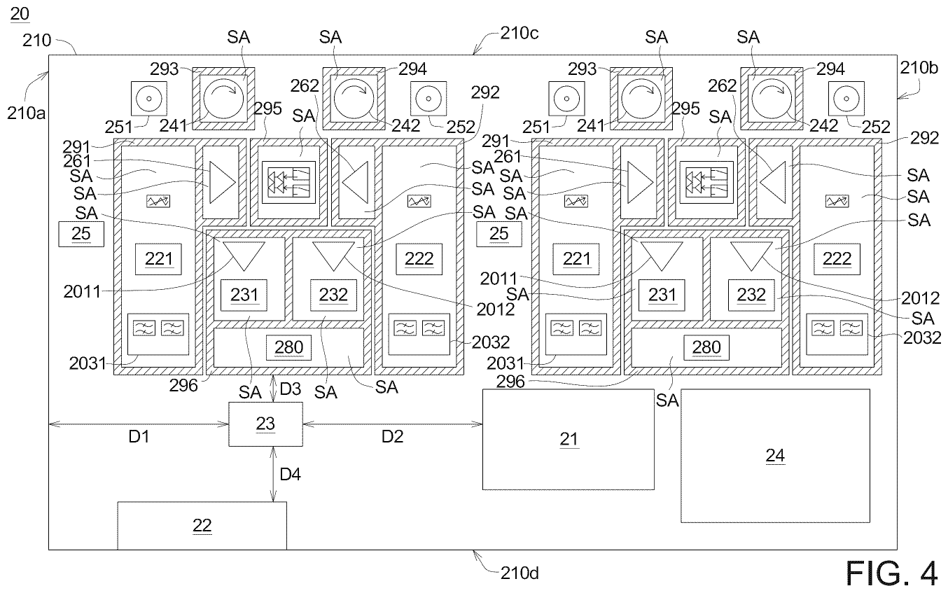

Please refer to FIG. 4, which is a top view illustrating the structural configuration of a communication system 20 according to a fourth embodiment of the present invention.

As shown in FIG. 4, the communication system 20 can include two communication devices 200 of the aforementioned second embodiment, a processing unit 21, a port 22, a frequency synthesizer 23, a converter 24, and a regulator 25. These components are disposed on a substrate 210 and located outside the two shielding frames 290 of the two communication devices 200, namely outside separated areas SA defined by shielding members 291 to 296 of the shielding frames 290. The substrate 210 is a single substrate. That is, the two communication devices 200 can share the same substrate 210, and the components disposed on the substrate 210 can be communicatively or electrically connected with each other as required. The substrate 210 has a first side 210a and a second side 210b opposite to each other in the left-right direction, and a third side 210c and a fourth side 210d opposite to each other in the up-down direction. Specifically, one of the two communication devices 200 is located adjacent to the first side 210a of the substrate 210, and the other one is located adjacent to the second side 210b. The port 22 and the frequency synthesizer 23 are disposed below one of the two communication devices 200, with the port 22 being adjacent to the fourth side 210d of the substrate 210. The processing unit 21 and the converter 24 are disposed below one of the two communication devices 200, and the regulator 25 is disposed between the two communication devices 200.

In this embodiment, the processing unit 21 can be a central processing unit and is electrically or communicatively connected to the two communication devices 200 for controlling the two communication devices 200 to respectively receive or transmit signals. The port 22 is used for connection to an external power supply. The frequency synthesizer 23 is electrically or communicatively connected to the two clock buffers 280 of the two communication devices 200, so as to evenly provide an operation frequency to the two clock buffers 280, thereby reducing problems caused by a small signal or delay from a single clock source within a limited space. The converter 24 can be a power converter electrically connected to the port 22, used to receive an external power supply (such as a DC power supply) from the port 22 and step down the external power supply to match the operating voltage required by the components of the communication system 20. The regulator 25 can be a low-dropout regulator, electrically connected to the converter 24 to receive the operating voltage therefrom, so as to regulate the voltage and provide a stable DC power supply.

In an embodiment, a distance D1 between the first side 210a of the substrate 210 and the frequency synthesizer 23 is equal to a distance D2 between the frequency synthesizer 23 and the processing unit 21. In this way, the frequency synthesizer 23 can maintain a predetermined distance from the processing unit 21, such that the operation of the frequency synthesizer 23 is not affected by the heat generated from the processing unit 21, while the frequency synthesizer 23 is not too far from the other one of the two communication devices 200 (i.e., the communication device 200 adjacent to the second side 210b of the substrate 210), thereby ensuring that the frequency synthesizer 23 can effectively transmit the operation frequency to the communication device 200 adjacent to the second side 210b. In another embodiment, a distance D3 between one of the two communication devices 200 (i.e., the communication device 200 adjacent to the first side 210a of the substrate 210) and the frequency synthesizer 23 is smaller than a distance D4 between the frequency synthesizer 23 and the port 22, such that the operation of the frequency synthesizer 23 is not affected by the heat generated from the port 22. In detail, the distance D3 can be defined as a distance between the shielding frame 290 of the communication device 200 adjacent to the first side 210a of the substrate 210 and the frequency synthesizer 23.

Accordingly, in this embodiment, by using the two communication devices 200, the communication system 20 can function as a 4T4R MIMO antenna system. When the communication system 20 as the 4T4R MIMO antenna system operates, the processing unit 21 typically generates relatively high heat, while the port 22 generates relatively low heat. If the frequency synthesizer 23 is too close to the processing unit 21, noise may be introduced into the system. Therefore, in this embodiment, the placement of the frequency synthesizer 23 is carefully designed. By making the distance D1 between the frequency synthesizer 23 and the first side 210a of the substrate 210 equal to the distance D2 between the frequency synthesizer 23 and the processing unit 21, and/or making the distance D3 between the frequency synthesizer 23 and the communication device 200 adjacent to the first side 210a smaller than the distance D4 between the frequency synthesizer 23 and the port 22, interference noise can be prevented. Furthermore, since the communication system 20 of this embodiment includes the communication devices 200 with shielding frames 290 configured with shielding members 291 to 296 to define separated areas, the isolation of noise interference can be better ensured compared with the communication system 10 of the third embodiment, thereby achieving a lower EVM.

As described above, the present invention provides a novel communication device and a communication system including the same. By designing a shielding frame capable of defining a plurality of closed separated areas therein, and arranging a first transceiver module, a second transceiver module, a first circulator, and a second circulator within the separated areas, the isolation of a multiple-input multiple-output antenna system can be enhanced, a low EVM can be achieved, and the quality of communication signals can be improved.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A communication device, comprising:
a substrate;
a first transceiver module disposed on one side of a surface of the substrate;
a second transceiver module disposed on the surface of the substrate and located on the other side opposite to the first transceiver module;
a first circulator disposed on the surface of the substrate and electrically or communicatively connected to the first transceiver module through the substrate to separate a transmitting path and a receiving path of the first transceiver module;
a second circulator disposed on the surface of the substrate and electrically or communicatively connected to the second transceiver module through the substrate to separate a transmitting path and a receiving path of the second transceiver module;
a first antenna module disposed on the surface of the substrate and electrically or communicatively connected to the first circulator through the substrate to receive or transmit a signal;
a second antenna module disposed on the surface of the substrate and electrically or communicatively connected to the second circulator through the substrate to receive or transmit a signal; and
a shielding frame disposed on the surface of the substrate, the shielding frame defining a plurality of closed separated areas therein, so as to distribute the first transceiver module and the second transceiver module in the separated areas, or to distribute the first transceiver module, the second transceiver module, the first circulator, and the second circulator in the separated areas.

2. The communication device according to claim 1, further comprising:
a clock buffer disposed on the surface of the substrate and in one of the plurality of separated areas of the shielding frame, the clock buffer being located between the first transceiver module and the second transceiver module, and electrically or communicatively connected to the first transceiver module and the second transceiver module through the substrate, to provide a operation frequency to the first transceiver module and the second transceiver module.

3. The communication device according to claim 1, wherein the first transceiver module includes a first transmitting unit and a first receiving unit, the first transmitting unit and the first receiving unit are respectively electrically or communicatively connected to the first circulator, and the first transmitting unit and the first receiving unit are distributed in the plurality of separated areas to isolate the first transmitting unit and the first receiving unit.

4. The communication device according to claim 1, wherein the second transceiver module includes a second transmitting unit and a second receiving unit, the second transmitting unit and the second receiving unit are respectively electrically or communicatively connected to the second circulator, and the second transmitting unit and the second receiving unit are distributed in the plurality of separated areas to isolate the second transmitting unit and the second receiving unit.

5. The communication device according to claim 1, wherein the shielding frame is an integrally formed component.

6. The communication device according to claim 1, wherein the shielding frame includes a plurality of shielding members separately disposed, and each of the shielding members defines at least one of the separated areas.

7. The communication device according to claim 6, wherein the first circulator and the second circulator are located in two different ones of the plurality of shielding members.

8. The communication device according to claim 1, wherein the first transceiver module includes a first receiving unit, the second transceiver module includes a second receiving unit, the first receiving unit and the second receiving unit include a shared receiving switch module, and the receiving switch module is disposed on the surface of the substrate and electrically or communicatively connected to the first circulator and the second circulator through the substrate.

9. A communication system, comprising:
two communication devices according to claim 1, wherein the substrates of the two communication devices are the same substrate, and the substrate has a first side and a second side that are opposite to each other in a left-right direction, one of the two communication devices is adjacent to the first side, and the other one of the two communication devices is adjacent to the second side;
a processing unit disposed on the substrate and located below said the other one of the two communication devices; and
a frequency synthesizer disposed on the substrate and located below said one of the two communication devices, wherein a distance between the frequency synthesizer and the first side of the substrate is equal to a distance between the frequency synthesizer and the processing unit.

10. The communication system according to claim 9, further comprising:
a port disposed on the substrate and located below the frequency synthesizer, wherein a distance between the frequency synthesizer and said one of the two communication devices is smaller than a distance between the frequency synthesizer and the port.
